(19) United States
(12) Patent Application Publication
(10) Pub. No.: US 2005/0144389 A1
(43) Pub. Date: Jun. 30, 2005

(54) Method, system, and apparatus for explicit control over a disk cache memory

(76) Inventors: Sanjeev N. Trika, Hillsboro, OR (US); Robert J. Royer JR., Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/748,307

(22) Filed: Dec. 29, 2003

(51) Int. Cl. G06F 12/00

(52) U.S. Cl. 711/129; 711/113

(57) ABSTRACT

A software organization that enables applications for accessing an interface that is exposed by a cache driver for reserving a portion of the cache for application use.

### BACKGROUND

1. Field

The present disclosure pertains to the field of disk cache memory. More particularly, the present disclosure pertains to memory management control over a disk cache memory.

2. Description of Related Art

Various applications, such as, databases, computer games and three dimensional (3D) world navigations, require large low-latency memory storage requirements. The preceding applications include complex data structures in order to best utilize the limited available system memory. Typically, it is advantageous for applications to store this data in non-volatile memory since the data is preserved despite system crashes, reboots, or a power fail condition.

Typically, disk drives have been utilized for the preceding applications. However, disk drives have very high latency (wait time for memory operation to be completed). Consequently, the high latency results in poor performance due to constantly retrieving data from the disk drive. Another solution is to use system main memory. However, system main memory is expensive and volatile. Therefore, this will result in low storage capacity and a short data lifetime. Another solution is to use disk caches with a non-volatile type of cache memory. However, cache management policies tend to be inefficient due to pre-configured caching policies and suffer from lack of control over the disk cache memory.

### BRIEF DESCRIPTION OF THE FIGURES

The present invention is illustrated by way of example and not limitation in the of the accompanying drawings.

FIG. 1 illustrates an apparatus utilized in accordance with an embodiment

FIG. 2 illustrates a software diagram utilized in accordance with an embodiment.

FIG. 3 illustrates a flowchart for a method in accordance with one embodiment.

### DETAILED DESCRIPTION

The following description provides method, system and apparatus for a cache to be utilized for providing applications with explicit cache memory management control. In the following description, numerous specific details are set forth in order to provide a more thorough understanding of the present invention. It will be appreciated, however, by one skilled in the art that the invention may be practiced without such specific details. Those of ordinary skill in the art, with the included descriptions, will be able to implement appropriate logic circuits, data structures, and software algorithms without undue experimentation.

As previously described, various problems exist for applications that require large non-volatile storage requirements with low latency. In contrast, in one aspect, the claimed subject matter utilizes a non-volatile cache memory (NV Cache) in between a main memory and a mass storage, such as, a disk drive in one embodiment. Also, the claimed subject matter depicts a software organization that enables applications for accessing an interface that is exposed by the NV cache driver for reserving a portion of the NV cache for application use. Therefore, the claimed subject matter also facilitates and provides the application to have explicit control over the data in the NV cache. In one embodiment, the NV cache is controlled by a plurality of predetermined functions that are supported by a driver for indirect or direct application calls. The predetermined functions are in addition to a standard I/O driver interface that is utilized by an operating system (OS), and can follow any standard memory management model. For example, some of the predetermined functions are:
Allocate ( ) , Get ( ) , Set ( ) , and Free ( ) function calls
File creation/deletion and read/write operations.

However, the claimed subject matter is not limited to the function names depicted. Rather, one skilled in the art appreciates utilizing different names for the predetermined functions that serve the same purpose. For example, an Allocate function that serves the purpose of allocating a portion of the memory may be called by a different name, such as, Reserve function that serves the same purpose. Likewise, a Get function that serves the purpose of reading a portion of the memory may be called by a different name, such as, a Read function that serves the same purpose.

FIG. 1 illustrates an apparatus utilized in accordance with an embodiment. In one aspect and embodiment, the apparatus depicts a novel architecture that enables a non-volatile cache (NV cache) to be coupled in between a main memory and a main storage with applications controlling the cache policy and/or a portion of the cache for explicit control by the application. In one embodiment, the apparatus may be implemented in a memory controller. In another embodiment, the apparatus may be implemented in a chipset. In yet another embodiment, the apparatus may be implemented in an application specific integrated circuit (ASIC). Also, the apparatus may be controlled or supervised by a driver in a software algorithm. For example, the software may be stored in an electronically-accessible medium that includes any mechanism that provides (i.e., stores and/or transmits) content (e.g., computer executable instructions) in a form readable by an electronic device (e.g., a computer, a personal digital assistant, a cellular telephone).For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals).

The main memory 104 is coupled to a central processor unit (CPU) 102 and receives requests to access data. In some instances, the main memory will not have the requested data and forwards the request to the data store. In one embodiment, the NV cache 106 is coupled in between the main memory and the data store to receive the request. Also, in the same embodiment, the mass storage is a disk drive.

In one embodiment, the NV cache is manufactured with a polymer memory.

In order to illustrate the operation of this apparatus, the next few figures and examples will clearly illustrate the operation of the NV cache.

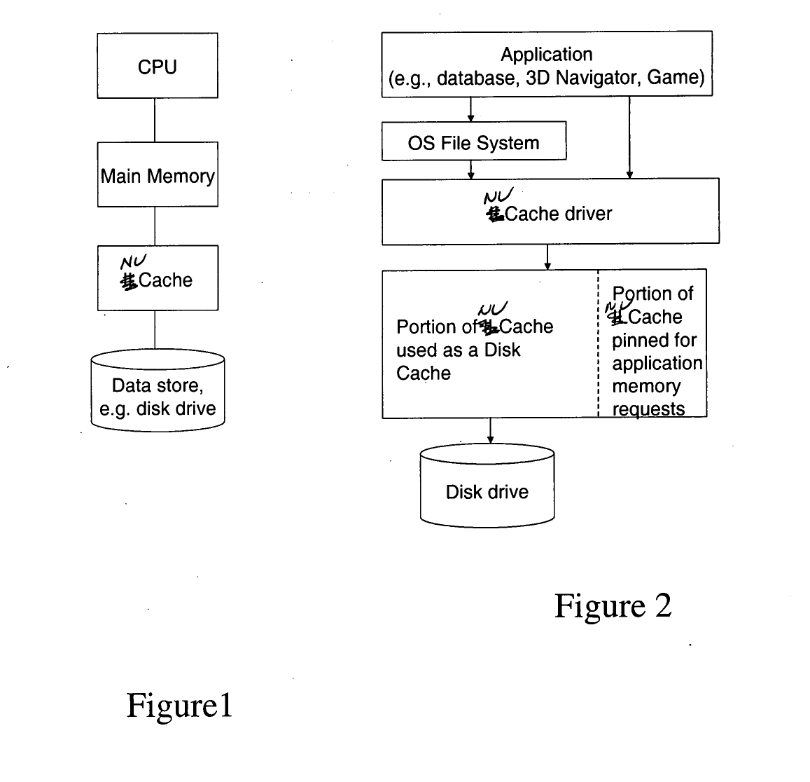

FIG. 2 illustrates a software diagram utilized in accordance with an embodiment. In one aspect, the software diagram depicts a software organization that enables applications for directly accessing an interface that is exposed by the NV cache drive for reserving a portion of the NV cache for application use. For example, the software organization depicts a mechanism and interface to an NV cache (as depicted earlier in connection with FIG. 1) for application use. Therefore, the software organization provides applications with explicit management control of the disk cache memory, NV cache.

For example, the software may be stored in an electronically-accessible medium includes any mechanism that provides (i.e., stores and/or transmits) content (e.g., computer executable instructions) in a form readable by an electronic device (e.g., a computer, a personal digital assistant, a cellular telephone).For example, a machine-accessible medium includes read only memory (ROM); random access memory (RAM): magnetic disk storage media; optical storage media; flash memory devices; electrical, optical, acoustical or other form of propagated signals (e.g., carrier waves, infrared signals, digital signals).

As previously discussed, the claimed subject matter describes various functions (interfaces) which the NVcache will implement. One such set of function may comprise the following:
Allocate ( ), Get ( ) , Set( ) , and Free( ) function calls
File creation/deletion and read/write operations

The allocate function (may also be described as an “interface”) facilitates reserving a predetermined portion of the NVcache for an explicit control by the application. For example, the allocate function may be used as follows:
Int numBytesToReserve=4000; (allocating # of bytes) NvCacheReservedMem_t* pNvMem;
Byte arrBytes [4000];
pNvMem=Allocate (numBytesToReserve);
if (pNvMem is not NULL){ if allocation was successful) then use the reserved(allocated) memory

The preceding code illustrates one example of allocating 4000 bytes of memory (based on the variable numBytesToReserve). However, the claimed subject matter is not limited to neither allocating 4000 bytes or to the specific function, variable or date structure names. One skilled in the art appreciates the ease and simplicity of choosing another number of bytes with a different value for the variable numBytesToReserve based at least in part on the application type. In one embodiment, the claimed subject matter determines whether the allocation was successful by checking the status of pNvMem. If the allocation was successful, the set function is initiated. For example, the set function may be used as follows:
initialize arrBytes to data you want to store in pNvMem.
Set (pNvMem, offset=0, numBytes=4000, arrBytes); (using the memory by initializing to the values stored in arrBytes)

The set function allows one to initialize (write) the allocated number of bytes to a predetermined value. For example, the predetermined value may be stored in arrBytes. Likewise, one may initialize either a subset of allocated bytes or the entire set of allocated bytes. Consequently, the set function results in initializing a subset or entire set of reserved non-volatile memory to predetermined values. Subsequently, the Get function allows one to read the value of the allocated bytes. The Get function could be utilized after the Set function or at a later point in time. Also, the Set and Get functions may be utilized once or multiple times on the same or different portions of the non-volatile cache for the same and/or different applications. For example, the Get function may be used as follows:
Get (pNvMem, offset=0, nurnBytes=4000, arrBytes);(Doing the read from memory) . . . and at some other time you want to release this memory from the nvCace:

Upon completion of a particular application or in the event one decides to utilize the allocated bytes for another application or the application does not want to exist for the next iteration the allocated bytes may be released (deallocated) by utilizing the following Free function:
Free (pNvMem).

As previously discussed in FIG. 1, the NV cache 106 may support the predetermined functions of Allocate, Get, Set, and Free by performing the following actions. In one embodiment, a pin bit is stored per cache-line in the cache-line metadata and the data allocation is done on a cache-line granularity.

For the allocate, the cache will:
Identify if we can reserve so many bytes. If not, return NULL.
Identify cache-lines to use to reserve these bytes.
Flush these cache-lines if they are dirty.
Mark them empty.
Pin these cache-lines
Return a pointer to a structure that identifies the cache-lines reserved
for this request.

For the set function the cache will:
NvCacheSet (pNvMem, offset, numBytes, databuffer)
Ensure that input params are valid (i.e., not null, and the data region referenced is in range)
Identify the cache-lines to use.
Copy data from dataBuffer to the applicable cache lines
Mark these lines valid (not empty).

For the Get function the cache will:
NvCacheGet (pNvMem, offset, numBytes, dataBuffer)
Ensure that input params are valid (i.e., not null, and the data region referenced is in range)
Identify the cache-lines to use, and ensure they are valid (not empty).
Copy data from the applicable cache lines into dataBuffer

For the Free function the cache will:
NvCacheFree (pNvMem)
Validate input param
Unpin the cache-lines
Mark them invalid

In an alternate embodiment, initially reserving a section of the cache memory upfront to be dedicated for application requests. The cache will then perform the following tasks to facilitate the function:
Runs a memory manager on the reserved section of the cache memory to satisfy the application requests. The cache may also dynamically change the size of the reserved portion of the cache memory for best utilization of the cache.

Various embodiments of the claimed subject matter may be provided as a computer program product, which may include a machine-readable medium having stored thereon instructions, which may be used to program a computer, or other electronic devices, to perform processes according to various embodiments. The machine-readable medium may include, but is not limited to, floppy diskettes, optical disks, CD-ROMs, magneto-optical disks, Read-only memory (ROMs), Random-only memory (RAM), Erasable Programmable only memory (EPROMs), Electrically Erasable Programmable only memory (EEPROMs), magnetic or optical cards, flash memory, or another type of media/machine-readable medium suitable for storing electronic instructions.

The software organization 200 depicts an application 202, such as, but not limited to, a database, three dimensional (3D) Navigator, or video game. The application communicates with an operating system file system 204 and an NV cache Driver 206 directly or indirectly through a software library to perform a function. In one embodiment, the NV cache driver resides in a kernel space. In one embodiment, the application generates an message to the NV cache driver to perform a function. For example, one function may be that the NV cache driver could reserve a first portion of the NV cache 208 to be exclusively used for memory requests for the particular application, while a second portion of the NV cache is utilized as a disk cache and is coupled to the disk drive.

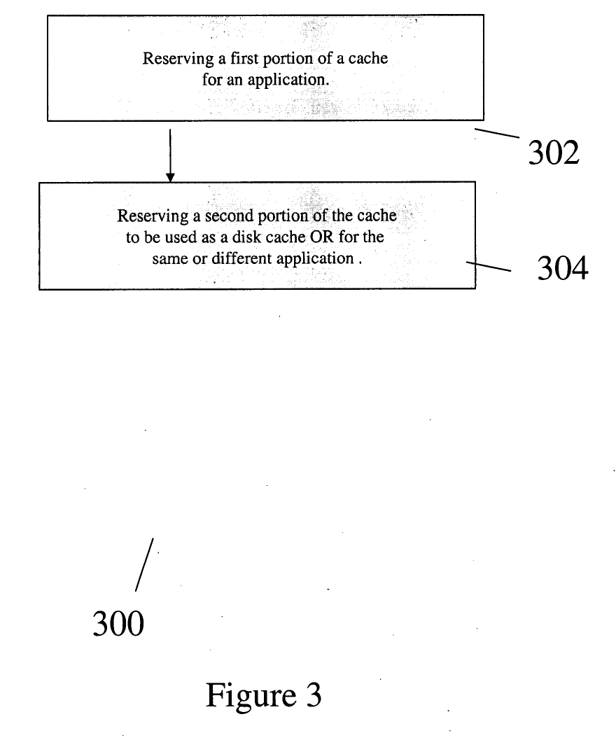

FIG. 3 illustrates a flowchart for a method in accordance with one embodiment. In one aspect, the flowchart depicts reserving a portion of a cache for application memory requests. A first portion of the cache is reserved for application memory requests, as illustrated by a block 302. The reserving of a portion of the cache may be used once or repeated multiple times for the same or different portions of the non-volatile cache for the same and/or different applications. In contrast, in one embodiment, a second portion of the cache is reserved to be used as a disk cache, as illustrated by a block 304. In this embodiment, the second portion of the cache is coupled to a disk drive. In an alternative embodiment, the second portion of the cache is reserved for another application rather than for a disk cache. Also, in one embodiment, the application may be a database, 3D navigator, or game. However, the claimed subject matter is not limited to the previous applications.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure.

1. A method for reserving a non-volatile cache for explicit control by an application comprising:
reserving a first portion of the cache for application memory requests based at least in part on a predetermined set of functions that are supported by a driver for application calls; and reserving a second portion of the cache for application memory requests.

2. The method of claim 1 wherein the predetermined set of functions comprises: Allocate, Get, Set, and Free.

3. The method of claim 1 wherein the predetermined set of functions allow for direct or indirect application calls.

4. A method for reserving a non-volatile cache for explicit control by an application comprising:
reserving a first portion of the cache for application memory requests based at least in part on a predetermined set of functions that are supported by a driver for application calls; and
reserving a second portion of the cache to be used as a disk cache.

5. The method of claim 4 wherein the predetermined set of functions comprises: Allocate, Get, Set, and Free.

6. The method of claim 1 wherein the predetermined set of functions allow for direct or indirect application calls.

7. An apparatus comprising:
a non-volatile cache, coupled to a main memory and a mass storage; and
the non-volatile cache to support a predetermined set of functions that are supported by a driver for application calls and a bit is set and cleared per affected cache-line in the cache-line metadata in the cache and the data allocation is done on a cache-line granularity.

8. The apparatus of claim 7 wherein the predetermined set of functions comprise: Allocate, Get, Set, and Free.

9. The apparatus of claim 7 wherein the predetermined functions allow for direct or indirect application calls.

10. The apparatus of claim 7 wherein the apparatus is to be implemented in either: a memory controller, a chipset, or an application specific integrated circuit (ASIC).

11. The apparatus of claim 8 wherein the non-volatile cache, in response to an Allocate function, will:
determine whether a predetermined number of bytes can be reserved,
if so, to identify cache-lines to use to reserve the predetermined number of bytes,
flush the cache-lines if they are dirty and mark them as empty,
pin these cache-lines, and
return a pointer to a structure that identifies the cache-lines reserved for this request.

12. The apparatus of claim 8 wherein the non-volatile cache, in response to a Set function, will:
determine that input paramaters are valid (not null) and a data region referenced is in range,
identify the cache-lines to use,
copy data from a data Buffer to the applicable cache lines and mark these lines valid (not empty).

13. The apparatus of claim 8 wherein the apparatus is supervised by a driver in a software algorithm.

14. The apparatus of claim 8 wherein the non-volatile cache, in response to a Get function, will:
determine that input parameters are valid (not null) and a date region referenced is in range,
identify the cache-lines to use and determine if they are valid (not empty), and
copy data from the applicable cache lines into a data Buffer.

15. The apparatus of claim 8 wherein the non-volatile cache, in response to a Free function, will:
determine that input parameters are valid (not null),
unpin the cache-lines,
and Mark the cache lines as invalid

16. An apparatus comprising:
a non-volatile cache, coupled to a main memory and a mass storage; and
the non-volatile cache to support a predetermined set of functions that are supported by a driver for application calls and the cache is specifically utilized for an application and the non-volatile cache does not require pin bits.

17. The apparatus of claim 16 wherein the predetermined set of functions comprise: Allocate, Get, Set, and Free.

18. The apparatus of claim 16 wherein the predetermined functions allow for direct or indirect application calls.

19. The apparatus of claim 16 wherein the apparatus is to be implemented in either: a memory controller, a chipset, or an application specific integrated circuit (ASIC).

20. The apparatus of claim 17 wherein the cache, in response to the predetermined set of the functions, will:
reserve a section of the cache for the application; and
invoke a cache manager on a pre-reserved portion of the cache to support the predetermined set of functions.

21. An article of manufacture comprising:
a machine-readable medium having a plurality of machine readable instructions, wherein when the instructions are executed by a system, the instructions provide to manage a cache memory for:
allocating a first portion of the cache memory for application memory requests based at least in part on a predetermined set of functions that are supported by a driver for application calls; and
initializing at least one byte of the first portion of the cache memory in response to the predetermined set of functions;
reading at least one byte of the first portion of the cache memory in response to the predetermined set of functions; and
deallocating at least one byte of the first portion of the cache memory in response to the predetermined set of functions.

22. The article of manufacture of claim 21 wherein the predetermined set of functions comprises: Allocate, Get, Set, and Free.

23. The article of manufacture of claim 21 wherein predetermined functions allow for direct or indirect application calls.
